(19) United States
(12) Patent Application Publication
(10) Pub. No.: US 2004/0251686 A1
(43) Pub. Date: Dec. 16, 2004

(54) Multi-taper and multi-pitch diameter API eight round thread coupling

(76) Inventors: Gregory K. Otten, Houston, TX (US); Martin M. Morrish, Plantersville, TX (US); Charles K. Ohlendorf, Magnolia, TX (US)

Correspondence Address: Carlos A. Torres, Browning Bushman P.C., Suite 1800, 5718 Westheimer, Houston, TX, 77057-5771, US

(21) Appl. No.: 10/457,773

(22) Filed: Jun. 10, 2003

(51) Int. Cl. F16L 25/00

(52) U.S. Cl. 285/333

(57) ABSTRACT

The taper and pitch diameter of a conventional API eight round thread coupling are varied over the axial length of the threads. The variations are held within the allowable tolerances of the applicable API specifications. The variations minimize the interference and galling occurring in the first and last engaged threads between the coupling and a pipe end having an externally formed API thread that is screwed into the coupling beyond the maximum API penetration.

### BACKGROUND OF THE INVENTION

1. Field of the Invention

The present invention relates to a thread design used to connect together the ends of threaded tubular members. More particularly, the present invention relates to an American Petroleum Institute (“API”) coupling thread design for engagement with an API external thread on a pipe end wherein the threaded pipe end and coupling are to be connected together according to a non-API procedure.

2. Setting of the Invention

The pipe that is used in the construction and processing of oil and gas wells is made in conformance with standards set forth usually by the manufacturer of the pipe or by the API. The present invention relates to the manufacture and assembly of pipe constructed in accordance with the API specifications.

The API has set forth specifications governing the dimensions and dimension tolerances of the threaded connectors used to secure together the ends of oil field tubulars. These specifications provide the dimensions and tolerances for variables such as thread taper, thread height, thread lead, thread pitch diameter and other variables. The specifications also set forth a make up procedure that provides for the amount of penetration of the male threaded member or “pin” into the female threaded member, referred to herein interchangeably as the coupling or “box.” The make up procedure also specifies other parameters such as the amount of torque employed to effect the desired make up and the lubricant to be used. The API pipe connections are among the most commonly used and least expensive connections in the oil field.

One of the most common API thread forms is the “eight round” thread form in which the thread tooth has a rounded thread crest and encircles the connection eight times per inch of axial development. The threads are provided on a large range of different pipe diameters. The threads of the pin and box of the API connection are cut along conforming taper cones and the thread form is commonly referred to as a tapered thread. In joining the pin and box components together, the tapered pin wedges into the tapered box as the pin threads are rotated into the box threads. Wedging the pin into the box produces a radial bearing pressure between the two components that cooperates with a pipe lubricant to seal the interface between the pin and box. The bearing pressure, and thus the sealing capability of the connection, is increased as the pin advances into the box. Connections of this type are termed “interference fits,” which primarily distinguishes them from “premium” connections that employ parallel threads and metal-to-metal shoulder engagement for achieving a seal.

The optimal API-recommended make up procedures for the eight round connection calls for the pin to be made up into the box three and one-half turns past the hand-tight engagement point. The maximum and minimum torque required for reaching the optimum engagement position are also specified. An optimally configured pin and box, when made up according to the recommended procedure, produce a bearing pressure adequate for properly sealing the connection.

In some sizes of API eight round pipe, the recommended make up procedure does not consistently provide a required sealing effect. The problem is due in part to manufacturing variances in the pin and box threads, metallurgical inconsistencies occurring in different pipe sizes, grades, weights and improper adherence to the recommended make up procedures. Tolerance stacking errors in the pin thread lead and in the coupling thread lead cause additional interference at the first and last engaged thread.

Various non-API make up procedures have been suggested for improving the sealing of API eight round connections. One procedure requires that the pin be advanced into the box beyond the API penetration requirement. Such a procedure is described in U.S. Pat. No. 4,962,579. The patented process improves the sealing capability of the connection, however the thread form of the pin and/or box may be mechanically damaged as a result of the over penetration of the pin into the box. The problem is most severe in certain sizes, weights and grades of pipe. The makeup process described in U.S. Pat. No. 4,962,579 is particularly problematic when API eight round couplings are employed with 7 ⅝ inch, 33 lbs. per foot and 39 lbs. per foot casing pipe. Galling of the first and last engaged threads between the pin and box is common when these sizes and weights of casing are assembled using the patented procedure.

It has also been suggested to modify the API thread design to improve the sealing capability of the connections. U.S. Pat. No. 4,588,213 suggests a continuous coupling thread form having three separate sections, each section having a different taper angle. The central section has a taper angle substantially the same as the API pin thread, the section nearest the mouth of the coupling has a smaller taper angle than the pin thread and the section furthest from the coupling mouth has a greater taper than the pin thread. The diameters of the threaded sections decrease from the mouth toward the center of the coupling. When mated with an API pin, the section nearest to the coupling mouth has a smaller taper angle than the pin thread, the central section has a taper angle substantially the same as the pin thread and the section furthest from the coupling mouth has a greater taper angle than the pin thread.

The coupling described in U.S. Pat. No. 4,588,213 requires a thread taper of 0.0938 inch per inch on the diameter in the section furthest from the coupling face. This taper exceeds the maximum allowable API thread taper of 0.0675 inch per inch on the diameter. The pitch diameter in this section is smaller than that of an API connection. Accordingly, the coupling does not meet the API specifications. The coupling cannot be gauged by a standard API plug gage. Such a coupling would not be entitled to carry the API monogram. Moreover, the proposed reduction of the pitch diameter in the area furthest removed from the coupling mouth increases the likelihood that over penetration of the pin into the box will cause thread galling in the reduced diameter area. The three taper, three pitch diameter coupling design described in U.S. Pat. No. 4,588,213, if used with the make up procedure suggested in U.S. Pat. No. 4,962,579, would significantly increase the probability of thread galling in the mated threads.

### Summary of the Invention

The internally threaded area of an eight round API coupling is modified within the permissible tolerances of the API specifications to reduce thread galling when the coupling is made up with an API pin that penetrates the coupling beyond the depth permitted by the API make up procedure. The threaded area is provided with first, second and third contiguous threaded areas, each having a taper that varies within a different range of the allowable taper tolerance and pitch diameters that vary within different ranges of the allowable pitch diameter tolerances. The first threaded area closest to the face of the box has a taper in the fastest range of the permitted API taper tolerance. The second area, in the central part of the box, has a taper in the midrange of the permitted API taper tolerance. The third threaded area, furthest from the face of the box, has a taper in the shortest range of the API taper tolerance. The pitch diameters in the first threaded area are as large as permitted within the upper limits of the range of the pitch diameter tolerance. The pitch diameters of the second threaded area are in the midrange of the API pitch diameter tolerance, and the pitch diameters in the third threaded area are as large as permitted within the upper limits of the range of the pitch diameter tolerance.

A coupling having the described characteristics can be gauged with conventional API gages and meets API specifications. The coupling construction minimizes the likelihood of thread galling in the first and last engaged threads of an API pin made up into the coupling. The coupling design is especially effective for preventing galling of the first and last engaged threads in API, eight round coupling and pin connections in 7 ⅝ inch pipe weighing 33 lbs. per foot and 39 lbs. per foot.

From the foregoing it may be appreciated that a primary object of the present invention is to provide an API, eight round thread coupling wherein an API, eight round thread pin may be threadedly advanced into the coupling to a depth that exceeds the API specified depth without damaging the threads of the pin or coupling.

A related object of the present invention is to modify an API round thread coupling within the permitted tolerances of the API specification for such a coupling to prevent thread damage when an API pin is threadedly advanced into the coupling to a depth beyond the API specified depth.

It is also an object of the present invention to provide a coupling design that produces an improvement in the sealing effectiveness between the coupling and a pipe pin without damaging the threads of the pin or coupling.

An important object of the present invention is to provide a coupling that meets accepted API specifications and can be used with an API pin connector to produce an effectively sealed connection.

A related object of the present invention is to provide a coupling that can be gauged with a standard API plug gage with an increased probability of detecting a coupling having an improper pitch diameter.

Another object of the present invention is to provide a coupling meeting API specifications that can be fully engaged with an API pin at a lower torque than that required to make up a conventional API pin and coupling.

### BRIEF DESCRIPTION OF THE DRAWINGS

FIG. 1 is a vertical quarter sectional view illustrating a conventional API coupling engaged with a conventional API pin with the pin penetrating the coupling beyond the recommended API make up position;

FIG. 2 is a quarter cross sectional view of a conventional API pin engaged in an API coupling incorporating the features of the present invention;

FIG. 2A is a schematic representation depicting the effect of the taper and pitch diameter variations employed in the coupling of the present invention;

FIG. 3 is a cross sectional view illustrating a 7 ⅝ inch, API Modified® eight round thread coupling constructed in accordance with the teachings of the present invention;

FIG. 4 is a schematic depiction of a plug gage in a conventional API coupling illustrating proper standoff in a properly constructed coupling;

FIG. 5 is a schematic depiction of a plug gage in a conventional API coupling illustrating thread interference near the face of the coupling limiting the advance of the plug gage into the coupling to produce a standoff that implies the oversized box has a proper pitch diameter;

FIG. 6 is a schematic depiction of a plug gage in a conventional API coupling illustrating thread interference near the base of the coupling threads limiting the advance of the plug gage into an oversize coupling and producing a standoff indicating that the coupling has a proper pitch diameter; and

FIG. 7 is a schematic depiction of a plug gage in an API coupling of the present invention illustrating thread interference only in the central threaded area of the coupling producing a standoff representative of the pitch diameter in the central area of the coupling.

### DESCRIPTION OF THE ILLUSTRATED EMBODIMENTS

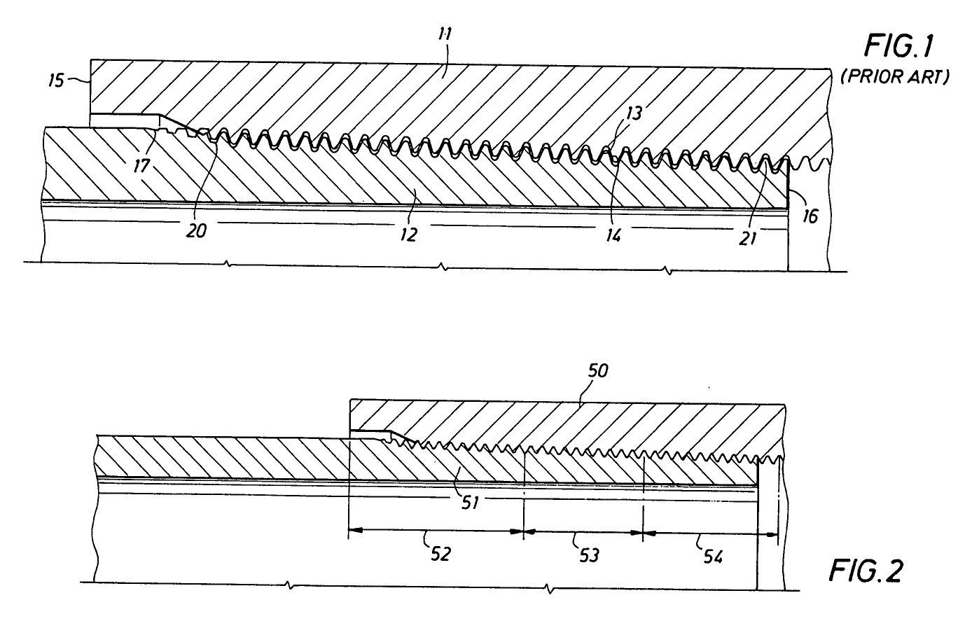

FIG. 1 illustrates a conventional API coupling 11 over engaged with a conventional API pin 12. Eight round, internal threads 13 formed within the coupling 11 engage corresponding eight round, external threads 14 provided along the external pipe end forming the pin 12. The threads 13 of the coupling 11 are developed by a thread tooth advancing along a decreasing diameter spiral in a direction away from a face 15 of the coupling. The pin threads 14 extend from a pin nose 16 and are formed by a thread tooth advancing along an increasing diameter spiral path that exits the pipe at a point 17. The exit point 17 is referred to as the “last scratch” or vanishing point of the pin thread. The flanks of the API pin and box threads are fully engaged rather than being axially spaced as illustrated in FIG. 1. The axial spacing between the threads 13 and 14 has been exaggerated for purposes of illustration.

The recommended API make up procedure for the coupling 11 and pin 12 specifies that the last scratch 17 be axially within plus or minus one thread of the axial position of the face 15 at the final make up position. A properly machined API pin and coupling will theoretically make up to a position at which the last scratch 17 is at the same axial position as the coupling face 15 when they are screwed together three and one-half turns beyond the “hand-tight” position of the engagement of the pin and box threads. This final make up position is sometimes referred to as the “power-tight” position.

FIG. 1 illustrates the pin 12 penetrating the box 11 beyond the recommended API penetration limit of one thread turn. The make up position illustrated in FIG. 1 is a non-API make up position, such as may be achieved using the technique taught in U.S. Pat. No. 4,962,579, in which the last scratch position is five and one-half turns beyond the hand tight make up position. Because of the converging tapers of the pin and box, the axial advancement of the pin into the box increases the radial bearing pressure exerted at the interface of the two components. When the two components are fabricated with normal machining variances, within the API tolerances, the additional penetration of the pin into the box can impose stresses sufficient to gall the engaged threads. Because of the accumulation of thread lead tolerance variations in both the pin and the box, the stresses can concentrate in the first and last engaged threads indicated at 20 and 21. These are the points at which galling is most frequently encountered when the pin over penetrates the coupling.

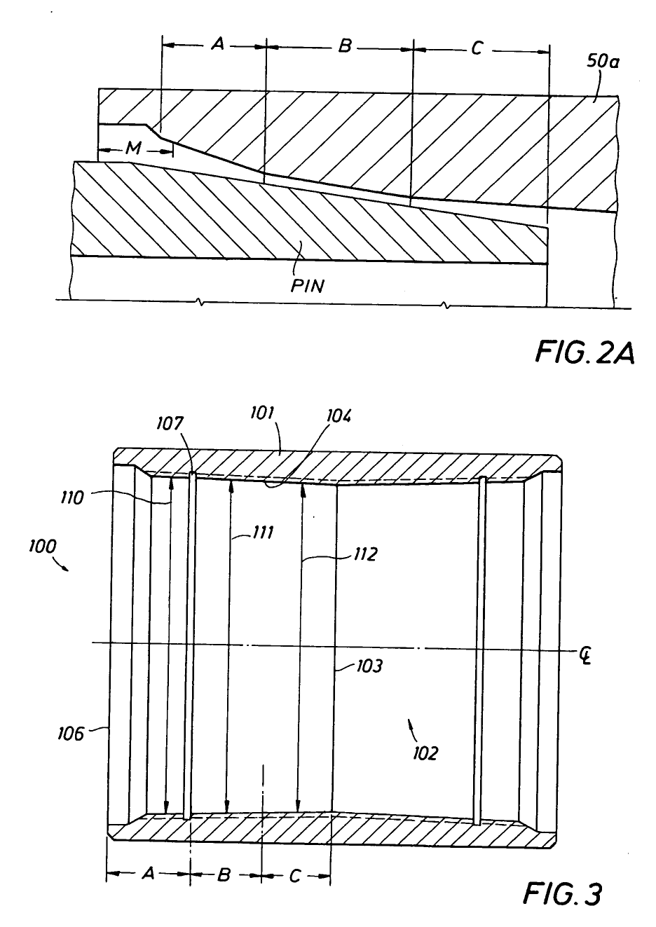

FIG. 2 illustrates a coupling 50 of the present invention designed to reduce the galling caused by over penetration of the conventional API pin 51. The coupling 50 is provided with contiguous internal threaded areas 52, 53 and 54 that have been constructed in accordance with the teachings of the present invention. The thread taper in the area 52 is at the fast end of the allowable API thread taper tolerance. The thread taper in the area 53 is in the midrange of the allowable API taper tolerance. The thread taper in the area 54 is in the slowest range of the allowable API thread taper tolerance. The pitch diameters for threads in the area in 52 are as large as possible within the upper range of the API pitch diameter tolerance. The pitch diameters for the threads in the central area 53 are constructed with dimensions that fall within the midrange of the allowable pitch diameter tolerance. The pitch diameters for the threads in the third area 54 are as large as possible within the upper range of the API pitch diameter tolerance. A coupling constructed within the described limits and mated with a pin having the maximum, worst-case variation of allowable API thread lead has a significantly lower probability of thread galling.

FIG. 2A is a schematic illustration of a coupling 50a constructed in accordance with the teachings of the present invention. The thread taper in the threaded area indicated at A is faster than that in the area indicated at B and C is slower than that in the area indicated at B. The taper on the pin P is nominal along its entire axial development. The pitch diameter measured at the API designated distance “M” from the face of the coupling is selected to be 0.00585 inch greater than the nominal API pitch diameter. This dimension establishes the pitch diameter cone for the area A. The pitch diameter for the area B is nominal. The pitch diameter for the area C is 0.003125 inch greater than nominal. The pitch diameters for the areas A and C exceed the nominal specified API “pitch diameters” by an amount that is well within the allowable API tolerance of +/−0.007813 inches.

FIG. 3 illustrates a 7 ⅝ inch API Modified®, eight round coupling, indicated generally at 100, constructed in accordance with the teachings of the present invention. The coupling 100 includes a tubular body 101 with an internally threaded area indicated generally at 102. The coupling is symmetrically constructed around a diametrical centerline 103. Both halves of the coupling are similar and only one of the halves will be described in detail. The threaded area 102 in one half of the coupling 100 includes threads 104 that extend along a thread pitch cone in a spiral path advancing axially away from a face 106 of the coupling and tapering radially inwardly toward a central axis of the coupling. An annular groove 107, characteristic of a Modified® coupling, is cut into the threaded area for holding a seal ring (not illustrated).

The internally threaded area 102 includes three separate threaded areas indicated generally at A, B and C corresponding to the areas designated in FIG. 2A. The area A extends axially 1.835 inches toward the coupling center 103 from the face 106 of the coupling. The thread taper in the area A may vary between 0.0650 and 0.0677 inch per inch on the diameter. The taper area B extends axially 1.250 inch from the end of the taper area A toward the centerline of the coupling. The thread taper in the area B may vary between 0.063 and 0.065 inch per inch on the diameter. The area C extends axially 1.550 inch from the area B to the center of the coupling. The thread taper in the area C may vary between 0.060 and 0.062 inch per inch on the diameter.

The API reference location for the pitch diameter of the coupling 100 is at 0.709 inch from the face of the coupling. This is the API dimension “M” for a 7 ⅝ inch coupling. The optimum pitch diameter at this location is specified as 7.52418 inches. The tolerance specified for the pitch diameter is +/−0.007813 inch. Using these values and the API dimensions and tolerances for the thread taper, it is possible to calculate the minimum and maximum pitch diameter for each thread along the threaded area 104. These pitch diameters will vary between the planes of two concentric, superimposed pitch cones, the inner cone established by the lower limit of the pitch diameter tolerance and the radially outer cone established by the upper limit of the pitch diameter tolerance. The thread pitch diameter at any given axial point along the threaded area of the coupling 100 will be associated with the dimension of the pitch cone at that location.

In accordance with the teachings of the present invention, a different range of pitch diameters is provided in each of the three threaded taper areas A, B and C. A pitch diameter dimension and location within each of the areas is specified to achieve the desired sealing and meet the objective of preventing galling of the first and last engaged threads when the coupling is made up with an API pin. The pitch diameter 110 in the area A is 7.48793 inches located 1.250 inch from the face 106 of the coupling. The pitch diameter 111 for the second area B is 7.41224 inches located 2.50 inches from the face 106 of the coupling. The pitch diameter 112 for the third area is 7.35902 inches located 3.750 inches from the face 106 of the coupling.

The three pitch diameters 110, 111 and 112 have dimensions that are within the tolerance allowed by API. In the case of the pitch diameters 110 and 112, the pitch diameters of the threads in the area A and C may vary between a minimum length pitch diameter dimension associated with a pitch diameter cone having the optimum API pitch diameter for the areas A and C and a maximum pitch diameter associated with a pitch diameter cone having maximum length pitch diameters within the API pitch diameter tolerance. The threads of the central taper area B are formed with pitch diameters that conform to the optimum API pitch diameter dimensions. In the preferred form of the invention, the machining tolerances for the selected pitch diameters are maintained to an accuracy of +0.000 inch, −0.004 inch. The effect of providing the three different pitch diameters over the threaded area 104 is to reduce the interference between the first and last engaged threads of the coupling and an API pin. The central area of the coupling maintains optimum sealing effectiveness with the engaged pin while the increased radial dimensions at each axial end of the coupling box thread reduce the stresses imposed on the first and last threads engaged with an API pin.

Galling of API pin and coupling threads made up to the API specification is pronounced in 7⅝ inch API eight round threaded and coupled pipe weighing 33 lbs. per foot and 39 lbs. per foot. The galling is exacerbated when the pin is advanced into the coupling beyond the recommended API maximum. A 7 ⅝ inch coupling 100 constructed with the following dimensions can substantially eliminate thread galling even when the pin is advanced beyond the recommended API penetration.

Threaded area A: tapers 0.065-0.0677 inches per inch on the diameter, pitch diameter 110, established at 1.250 inch from the face 106 of the coupling, 7.48793 inches, +0.000 inch, −0.004 inch.

Threaded area B: taper 0.063-0.065 inches per inch on the diameter; pitch diameter 111 established at 2.500 inches from the face of the coupling, 7.41224 inches, +0.000 inch, −0.004 inch.

Threaded area C: taper 0.060-0.062 inches per inch on the diameter; pitch diameter 112 established at 3.750 inches from the face of the coupling, 7.35902 inches, +0.000 inch, −0.004 inch.

The standard API tolerance on pitch diameter is +/−0.007813 inch, which is related to the taper tolerance of 0.0625 inches per inch, and is obtained by dividing the taper tolerance by the number of threads per inch. The preferred form of the invention limits the pitch diameter tolerance to +0.000 inch, −0.004 inch. Using the specified pitch diameters in a 7⅝ inch coupling, reduces the diametrical interference at the mouth of the coupling by 0.00585 inch and reduces the diametrical interference at the base of the thread area near the center of the coupling by 0.00313 inch.

Finite element analysis of an API 7 ⅝ inch, 8 round pin mated with a coupling of the present invention using the characteristics of P-110 steel and a wall thickness of 0.430 inch (33 lbs. per foot) determined a reduction of the Von Mises (VME) stress of approximately 10,000 psi on the last three engaged threads as compared with a standard taper design conventional API coupling. The stress in the middle of the coupling was determined to be similar to that found in a conventional API coupling. The finite element analysis of a 0.500 inch wall connection (37 lbs. per foot) produced similar results. The analysis predicts a five percent reduction in make up torque with a coupling of the present invention. The peak VME stress at the last engaged threads on the coupling of the present invention is ten percent lower than that of the standard API coupling. The thread contact stress in the coupling of the present invention is five percent lower than that on the standard API design. The analysis predicted that the structural characteristics of the coupling of the present design would not change with the taper modification.

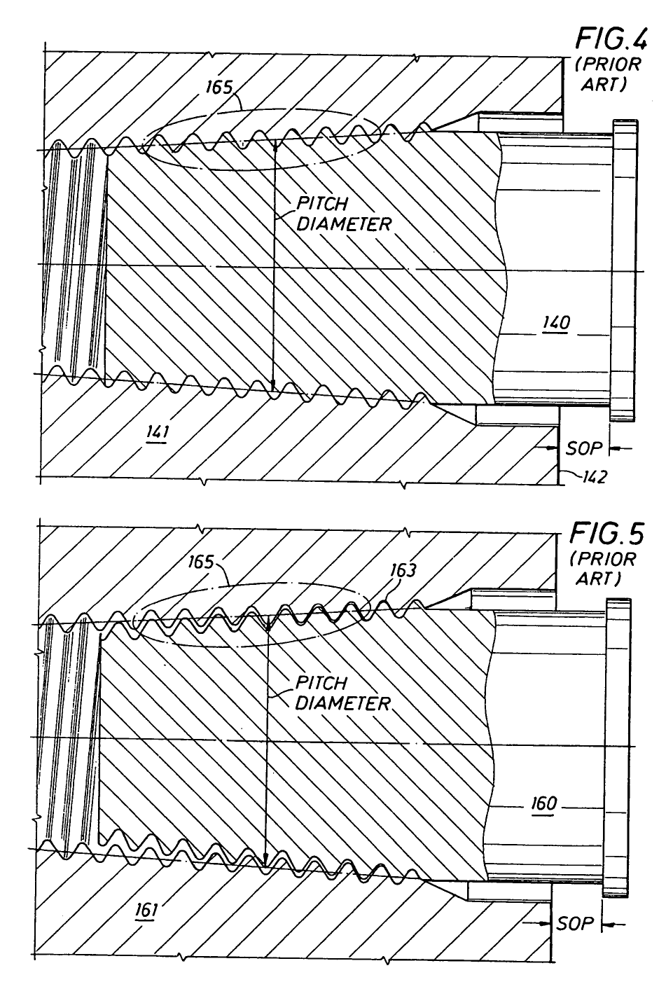

An added benefit of the coupling design of the present invention is that it permits more reliable gauging when using a conventional plug gage. The coupling thread of the present invention provides for consistently enlarged pitch diameters at the beginning and end of the threaded area. The result is that the plug gage is not as likely to be limited in its penetration of the coupling by out of tolerance pitch diameters at either end of the coupling threaded area. This feature is illustrated in FIGS. 4-7.

FIG. 4 schematically illustrates an API plug gage 140 made up into an API eight round coupling 141. At a hand tight position, the gauge 140 stands off from the face 142 of the coupling 141 by the amount SOP. The pitch diameter of the coupling 141 matches the pitch diameter of the plug gage 140 along the axial development in the threads of interest area 165. The API standoff of the plug gage 140 in the coupling 141 correctly indicates that the coupling has been properly constructed.

FIG. 5 illustrates a plug gage 160 engaged in a coupling 161. The pitch diameter of the coupling 161 in the threaded area indicated at 163 is the allowable API pitch diameter length. The plug gage has stopped at a standoff position SOP that indicates the coupling has an acceptable pitch diameter. However, the pitch diameter of the coupling in the area 165 is greater than the allowable API pitch diameter. An API pin made up into the coupling 161 is likely to fail or leak.

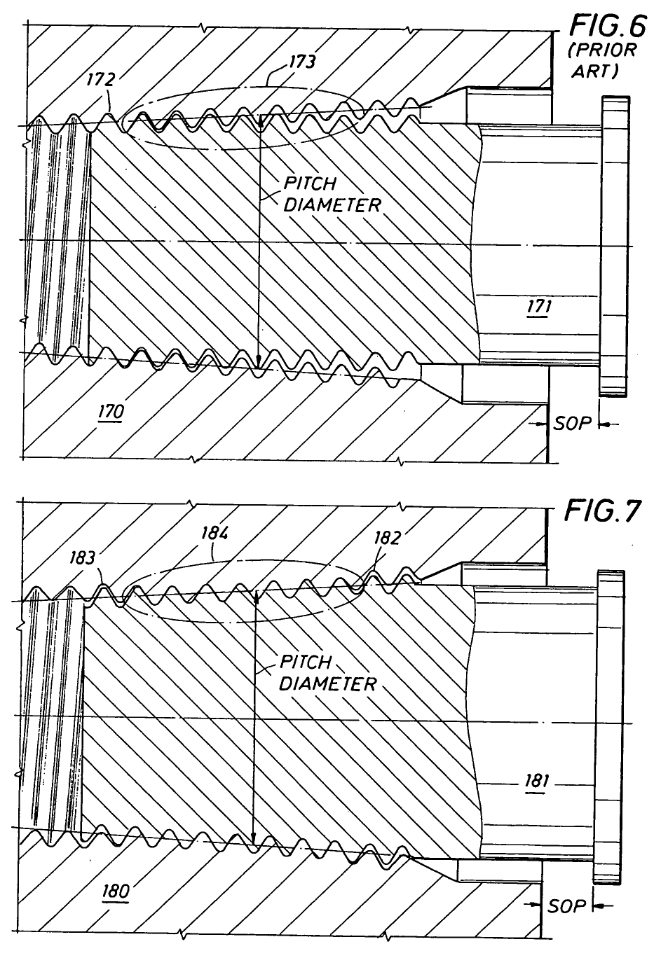

FIG. 6 illustrates a problem similar to that illustrated in FIG. 5. A coupling 170 is illustrated being gauged by a plug gage 171. The plug gage is illustrated being at a standoff position SOP indicating that the coupling 170 meets the API pitch diameter requirements. In fact, however, the pitch diameter of the coupling is within API tolerance only at a point 172 where it engages and restricts further penetration of the plug gage. The pitch diameter is greater than the API tolerance in the thread area 173. As with the coupling illustrated in FIG. 5, a pin made up into the coupling 170 is likely to leak or otherwise fail.

FIG. 7 illustrates a coupling 180 constructed in conformance with teachings of the present invention engaged with an API plug gage 181. The taper and pitch diameter tolerances employed in constructing the threads 182 and 183 of the coupling 180 increase the radial spacing of the threads 182 and 183 away from the threads of the plug gage 181, reducing the likelihood of interference that would affect the penetration of the plug into the coupling. As a result, the plug is more likely to be limited in its standoff by engagement with the threads of interest 184. An indication of a correct standoff based on interference with threads 184 is more likely to produce a correct indication of compliance with the API pitch diameter and taper requirements.

While a preferred form of the invention has been described in detail herein, it may be appreciated that various modifications in the described design and construction may be made without departing from the spirit or scope of the present invention which is more fully defined in the following claims.

1. An API, eight round coupling having an internal threaded area with threads extending along a thread pitch cone in a spiral path advancing axially away from a face of said coupling and tapering inwardly toward a central axis of said coupling, said internal threaded area having threads constructed in compliance with API specified dimensions and tolerances for thread taper and thread pitch diameter including an optimum thread taper value and an optimum pitch diameter value for the threads in said internal threaded area, comprising:
a first threaded area nearest said face of said coupling and included in said internal threaded area;
a second threaded area adjoining said first threaded area and included in said internal threaded area;
a third threaded area joining said second threaded area and included in said internal threaded area;
threads in said first threaded area having a thread taper diameter that varies in value only from said optimum API thread taper value to a maximum API thread taper value within said thread taper tolerance;
threads in said second threaded area having a thread taper diameter that may vary in value within a midrange from said optimum API thread taper value; and
threads in said third threaded area having a thread taper diameter that varies in value only from said optimum API thread taper value to a minimum API thread taper value within said thread taper tolerance.

2. A coupling as defined in claim 1, wherein:
said first threaded area includes pitch diameters that may vary between a pitch diameter associated with a pitch diameter cone having said optimum pitch diameter and a pitch diameter associated with a pitch diameter cone having a maximum length pitch diameter within said pitch diameter tolerance; and
said third threaded area includes pitch diameters that may vary between a pitch diameter associated with a pitch diameter cone having said optimum pitch diameter and a pitch diameter associated with a pitch diameter cone having a maximum pitch diameter within said pitch diameter tolerance.

3. A coupling as defined in claim 2, wherein said first and third threaded areas have pitch diameters that may vary only between the optimum and the maximum pitch diameters specified by API for eight round threads.

4. A coupling as defined in either of claims 1 through 3 wherein:
said coupling is a 7⅝ inch eight round API coupling;
the thread taper in said first threaded area varies from 0.065 to 0.0677 inches per inch on the diameter of said coupling;
the thread taper in said second threaded area varies between 0.063 and 0.065 inches per inch on the diameter of said coupling; and
the thread taper in said third threaded area varies from 0.060 to 0.062 inches per inch on the diameter of said coupling.

5. A coupling as defined in claim 4 wherein:
a pitch diameter at 1.250 inches from the face of the coupling is 7.48793 inches, +0.000 inch, −0.004 inch;
a pitch diameter at 2.500 inches from the face of the coupling is 7.41224 inches, +0.000 inch, −0.004 inch; and
a pitch diameter at 3.750 inches from the face of the coupling is 7.35902 inches, +0.000 inch, −0.004 inch.

6. A coupling as defined in either of claims 1 through 3, wherein:
a pitch diameter at 1.250 inches from the face of the coupling is 7.48793 inches, +0.000 inch, −0.004 inch;
a pitch diameter at 2.500 inches from the face of the coupling is 7.41224 inches, +0.000 inch, −0.004 inch; and
a pitch diameter at 3.750 inches from the face of the coupling is 7.35902 inches, +0.000 inch, −0.004 inch.

7. A coupling as defined in claim 6 wherein said pitch diameters are formed within a tolerance of +0.000 inches, −0.004 inches.

8. A coupling as defined in claim 4 further comprising an annular groove formed in said internal threaded area for holding an elastomeric seal ring.

9. A coupling as defined in claim 6 further comprising an annular groove formed in said internal threaded area for holding an elastomeric seal ring.

10. A. method of constructing an API eight round thread box, comprising:
forming a first threaded area adjacent a face of said box, said first threaded area having a thread taper only within an upper range of an API thread taper tolerance;
forming a second threaded area adjacent said first threaded area in a central area of said box, said second threaded area having a thread taper within a midrange of said API thread taper tolerance; and
forming a third threaded area adjacent said second area in a base of said box, said third threaded area having a thread taper within a lower range of said API thread tolerance.

11. A method as defined in claim 10 further comprising forming the threads in said first threaded area with pitch diameters that may vary between nominal and maximum values of an API specification for pitch diameters.

12. A method as defined in claim 11 further comprising:
forming a first threaded area adjacent a face of said coupling having a thread taper of 0.065-0.0677 inches per inch on the diameter of said coupling, said first threaded area having a pitch diameter established at 1.250 inches from said face of said coupling of 7.48793 inches, +0.000 inch, −0.004 inch;
forming a second threaded area adjacent said first threaded area having a thread taper of 0.063-0.065 inches per inch on the diameter of said coupling, said second area having a pitch diameter established at 2.500 inches from said face of said coupling of 7.41224 inches, +0.000 inch, −0.004 inch; and
forming a third threaded area adjacent said second threaded area having a thread taper of 0.060-0.062 inches per inch on the diameter of said coupling, said third threaded area having a pitch diameter established at 3.750 inches from said face of said coupling of 7.35902 inches, +0.000 inch, −0.004 inch.

13. A method as defined in claim 12 wherein said pitch diameters are formed within a tolerance of +0.000 inch, −0.004 inch.
